(19) United States
(12) Patent Application Publication
(10) Pub. No.: US 2009/0106667 A1
(43) Pub. Date: Apr. 23, 2009

(54) DIVIDING A SURFACE OF A SURFACE-BASED COMPUTING DEVICE INTO PRIVATE, USER-SPECIFIC AREAS

(75) Inventors: RUTHIE D. LYLE, DURHAM, NC (US); AL CHAKRA, APEX, NC (US); MONICA S. HARRIS, WAKE FOREST, NC (US)

Correspondence Address: PATENTS ON DEMAND, P.A. IBM-RSW, 4581 WESTON ROAD, SUITE 345, WESTON, FL, 33331, US

(73) Assignee: INTERNATIONAL BUSINESS MACHINES CORPORATION, ARMONK, NC (US)

(21) Appl. No.: 11/875,216

(22) Filed: Oct. 19, 2007

(51) Int. Cl. G06F 3/01

(52) U.S. Cl. 715/750

(57) ABSTRACT

The present invention discloses a solution for defining a private user area in a surface based computer. The solution can identify a surface of a surface based computer. At least one private user area can be defined for the surface. A region of the surface can be demarcated for each defined private user area. Input/output for each demarcated private user area can be handed in a manner specific to the private user area, which is different from how input/output is handled for other portions of the surface. In one embodiment, different users can be associated with multiple ones of a set of two or more different private user areas. Each user can concurrently utilize their own private user area as if that private user area was a computing space dedicated to that user.

### BACKGROUND

1. Field of the Invention

The present invention relates to the field of surface based computing and, more particularly, to dividing a surface of a surface-based computing device into private user specific areas.

2. Description of the Related Art

Surface based computing turns an ordinary tabletop into a dynamic surface that provides interaction with all forms of digital content through natural gestures, touch and physical objects. A key component to a surface based computer is a “multi-touch screen”, which accepts input from multiple fingers and multiple users simultaneously, allowing for complex gestures, including grabbing, stretching, swiveling, and sliding virtual objects across a tabletop.

The display area of surface-based computing devices can vary from relatively small areas, such as that of a small desk, to relatively large areas, such as a conference table surface. At present, multiple individuals positioned around a surface based computing device can each provide input sensed by the surface based computing device, which can result in unintelligible combinations of input. This situation is analogous to two different users moving and controlling different mice (or keyboards) connected to the same computer at the same time. From a computer's (or surface based device's) perspective, a serial, time ordered, stream of input is received and processed. From the user's perspective, their input is garbled or intermixed with that of the other user. Currently, surface-based computing devices function as a single computing session, and all touch inputs, whether they are from the same user or not, are treated as an input stream provided within the single computing session.

FIG. 1 (Prior Art) shows a schematic diagram of a conventional surface based computing device 100. Although the arrangements of device 100 are typical, variations of these components can be combined to form a device, which is still considered surface based computing device. In other words, the definition of a surface based computing device 110 is not to be limited to those typical components shown in FIG. 1. As shown device 100 can include a screen 105, a computing unit 110, a display projector 115, and a set of infrared projectors 120.

Computing unit 110 can contain one or more central processing units able to perform computing actions for the surface based device 100. The computing unit 110 can include many of the same components found in everyday desktop computers, such a CPU, a motherboard, RAM, a graphics card, a WIFI transceiver, a BLUETOOTH transceiver, and the like.

The screen 105 can be a horizontal surface that can incorporate multi-touch sensors. The touch-sensitive display can recognize objects by their shapes or by scanning tags (e.g., RFID tags) embedded in objects resting on the surface of screen 105. The multi-touch screen 105 can be capable of processing multiple inputs from multiple users.

Infrared projectors 120 can project infrared light onto screen 105 to be used for multiple touch sensing by computing unit 110. A “machine vision” of the surface based computing device 100 can operate in a near-infrared spectrum, such as by using an 850 nanometer-Wavelength LED light source aimed at the display 105. When objects touch the tabletop, the light reflects back and is picked up by multiple infrared cameras with an acceptable net resolution.

The display projector 115 can used rear-projection technologies, such as Digital light Processing (DLP) technologies, to project visible images to the display 105. A resolution of the visible screen can be different from the machine vision or invisible screen. For example, the visible screen can have a resolution of 1024×768, while the invisible resolution from the projectors 120 can be 1280×960, which can allow for better recognition at the edges of the display.

### SUMMARY OF THE INVENTION

The current invention discloses a solution for dividing a surface area of a surface-based computing device into two or more independent virtual workspaces. Once divided, input/output of each of the independent workspaces will be distinguished from input/output of other workspaces. For example, if two users were utilizing a surface based computing device, the surface can be divided between them into two private user areas. In one arrangement, private user areas can be associated with different user profiles and permission settings. In one configuration, different private user areas can represent different virtual machines, each dedicated to a specific user. In another configuration, private areas can be user-distinguished areas of an application which executes across the entire surface of the surface based computing device.

The disclosed invention can also allow specification of unused or deactivated surface divisions. For example, if a user wants to use part of the screen area as typical table space, for placing papers or a drinking glass, they can define the area as unused screen area. Hence, inadvertent inputs are not detected when a glass, paper, and the like are moved. Additionally, real-time adjustments for the surface divisions are contemplated. For example, if a third person sits around a surface based computing device having two divisions, these divisions can further dynamically subdivide into three sections, permitting a private work area for each person.

The present invention can be implemented in accordance with numerous aspects consistent with the materials presented herein. One aspect of the present invention can include a method for defining a private user area in a surface based computer. The method can identify a surface of a surface based computer. At least one private user area can be defined for the surface. A region of the surface can be demarcated for each defined private user area. Input/output for each demarcated private user area can be handed in a manner specific to the private user area, which is different from how input/output is handled for other portions of the surface. In one embodiment, different users can be associated with multiple ones of a set of two or more different private user areas. Each user can concurrently utilize their own private user area as if that private user area was a computing space dedicated to that user.

Another aspect of the present invention can include a surface based computing device that includes a surface configured to detect input and to visually present output. The surface can be configured to be divisible into a plurality of private user areas. Each of the private user areas can be a demarcated area of the surface to be used by a specific user. Different users can concurrently utilize different ones of the private user areas.

Still another aspect of the present invention can include an interface for a surface based computer. The interface includes a graphical user interface having a set of private user areas. Each of the private user areas can be a demarcated sub area of the total area of the graphical user interface. The total area can be concurrently utilized by a plurality of different users; each user of the plurality can be associated with one of the private user areas. Input provided within a demarcated sub area can correspond to a private user area and can be attributed to a specific one of the users. This input can be processed separately from input received from another one of the demarcated sub areas corresponding to a different private user area. Output provided via each of the demarcated sub areas corresponding to a private user area can be directed to a specific one of the users. The output can be processed separately from output directed to another one of the demarcated sub areas corresponding to a different private user area.

It should be noted that various aspects of the invention can be implemented as a program for controlling computing equipment to implement the functions described herein, or as a program for enabling computing equipment to perform processes corresponding to the steps disclosed herein. This program may be provided by storing the program in a magnetic disk, an optical disk, a semiconductor memory or any other recording medium. The program can also be provided as a digitally encoded signal conveyed via a carrier wave. The described program can be a single program or can be implemented as multiple subprograms, each of which interact within a single computing device or interact in a distributed fashion across a network space.

### BRIEF DESCRIPTION OF THE DRAWINGS

There are shown in the drawings, embodiments which are presently preferred, it being understood, however, that the invention is not limited to the precise arrangements and instrumentalities shown.

FIG. 1 (Prior Art) is a schematic diagram of a system of a surface-based computing device.

FIG. 2 shows a number of illustrative scenarios for a surface based computing device implementing private user areas in accordance with an embodiment of the inventive arrangements disclosed herein.

FIG. 3 is a schematic diagram of a system for dividing the display area of a surface-based computing device into private user areas in accordance with an embodiment of the inventive arrangements disclosed herein.

FIG. 4 illustrates a configuration for dividing the display area of a surface-based computing device into private user areas in accordance with an embodiment of the inventive arrangements disclosed herein.

### DETAILED DESCRIPTION OF THE INVENTION

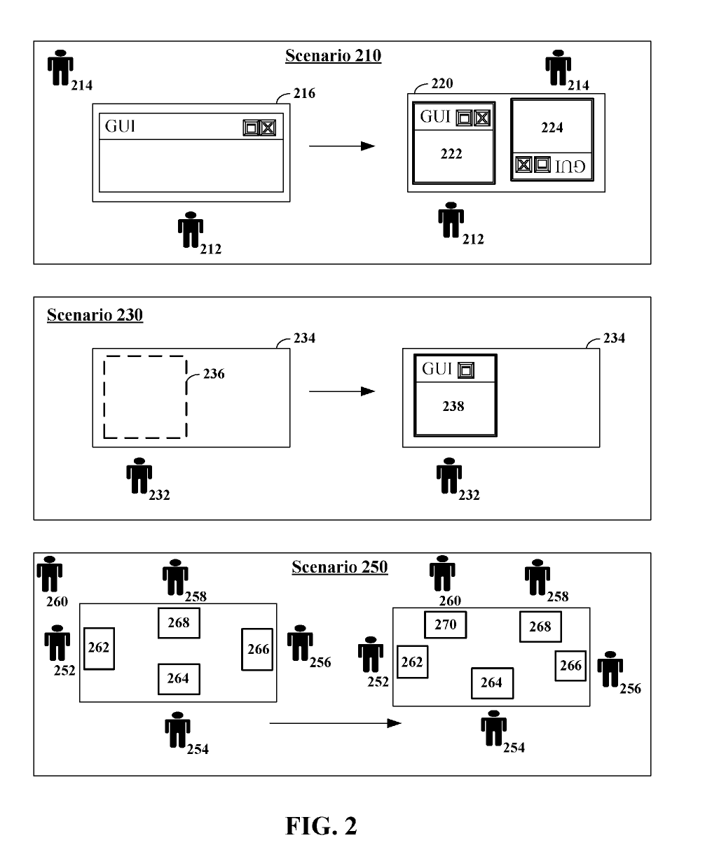

FIG. 2 shows a number of illustrative scenarios 210, 230, 250 for a surface based computing device implementing private user areas in accordance with an embodiment of the inventive arrangements disclosed herein. Generally, private user areas are sub regions of a surface of a surface based computing device, which are dedicated computing spaces for use by a specific user. That is, private user areas present output directed for a single user and accept input provided by a single user. Multiple private user areas can be active for a single surface based computing device and can be concurrently used by different users.

Scenario 210 shows an initial user 212 utilizing an entire surface area 216 of a surface based computer at a point in time when another user 214 approaches the surfaced computer to use it concurrently. Once user 214 is identified and/or authenticated to use the surface based computer, the screen area 220 can be dynamically divided into two private user areas 222 and 224. Private area 222 can be an area utilized by user 212, which is oriented to face user 212. The private user area 222 can represent an “uninterrupted” yet resized computing space that is used to continue the computing session conducted within surface area 216 of the surface based computer. Private user area 224 can be a computing space oriented for user 214, which is used by user 214. Scenario 210 is not limited to two users 212, 214 and any number of users (possibly up to a maximum limit based upon capabilities of the surface based computing device) can concurrently utilize the surface based computer. As a number of users of the surface based computing changes, an equivalent change in the number of private user areas 222, 224 can occur. Changes to the number of private user areas 222, 224 active for a surface based computer can cause a size and position of all private user areas 222, 224 to dynamically change. Not all private user areas 222, 224 established for a surface based computer need be the same size.

Scenario 230 shows one contemplated situation where a user 232 specifies a region 236 of a surface area 234 of a surface based computer. For example, the user can outline area 236 using their finger to “draw” a desired region 236. Once the region 236 is defined, a private user area 238 sized and positioned to fill the region 236 can be activated. Optional authentication and authorization can be required before user 232 is permitted to define region 236 and/or before a private user area 238 is created. A created private user area, such as private user area 238, can have a set of established privileges and configuration settings established that are specific to those associated with user 232.

It should be appreciated that a number of different technologies can be used to implement private user areas 222, 224, 238 depending upon desired implementation results. For example, in one embodiment, each private user area 222, 224, 238 can represent a virtual machine implemented using virtualization technologies, where the virtual machine operates from a user's perspective as if it is a distinct physical machine. In another embodiment, each private user area 222, 234, 238 can represent a “segment” of a single machine, which is able to be used concurrently by multiple users. Each user can be provided with a user specific window management session. For instance, an operating system (e.g., UNIX) can be used for the surface based computer that separates windows management or interface functions from operating system core operating system functions and that supports multiple users. In another implementation, a variant of virtual desktops can be established that permits different “virtual desktops” to be presented within the private user areas 222, 224, 238. In yet another implementation, a single executing application can establish private user areas 222, 224, 238.

This situation involving a single executing application is illustrated by scenario 250, where initially four users 252, 254, 256, 258 can interact with each other in a multi-player “game”, such as a poker application. Each player's (252-258) cards and playing selections can be presented within a player's private user area 262-268. When an additional player 260 enters the game, a new private user area 270 can be established, which shifts a position and/or size of existing private user areas 262-268 as shown.

The scenarios 210, 230, 250 are intended to introduce concepts associated with private user areas and are not intended to be comprehensive nor are they to be interpreted in a fashion that limits the scope of the claimed invention. Additionally, the scenarios 210, 230, 250 can each be used in numerous contexts, each having context specific implementation specifics.

The arrangements shown as scenario 250 can, for example, represent a table in an airport passenger lounge. In this case, users 252-260 of the surface based computing device can have a proscribed relationship with the airline, such as a Platinum, Gold, or Silver Membership. In this situation, a percentage of an overall surface of a surface based computing device and/or functionality available to a user 252-260 can be dependent upon a relationship level. For example, users 252 and 256 can be Silver members, which permit them to access internet functionality through their private user areas 262, 266. Users 254, 258 can be Gold members, which permits them to access internet functionality, a user-specific networked storage space (maintained by the airlines), and to use an office productively suite via their private user areas 264, 268. User 260 can be a Platinum member, which permits a size of private user area 270 to be twice that of any other area 262-268, and which permits a functionality provided by 270 to be at least as capable as areas 264 and 268.

In the airport passenger lounge example, the user can be determined in many ways. For example, a membership card carried by users 252-260 can be placed upon the surface based computing device, which results in the device scanning information to identity the user from the card. A magnetic strip or RFID region of a card, which is readable by the surface based computing device, can also be used to identify a user 252-260. Users 252-260 can also enter a membership identification number and password. Further, biometric identification techniques can be used, such as finger print reading, eyeball scanning, facial structure matching based on comparing a captured image against a stored image, and the like.

In still another example, which can be a derivate of scenario 210 or 230, a surface based computing device can be placed proximate to a waiting queue, such as a line of people waiting for a teller. While waiting in line, a user can be provided with a private user area, in which details of a desired teller interaction can be entered. As the user moves along the queue, the private user area associated with the user can move in a corresponding fashion. When the user ultimately is granted access to a teller station, the information for the transaction can be automatically provided to the teller from the private user area, which can substantially decrease person-to-teller interaction time.

In yet another example, a set of one or more surface based computing devices can be first come first serve devices available to users. For example, the surface based computing device can be positioned in a Department of Motor Vehicle office, where private user areas of the device are used to take a driving exam. In this situation, numbers can be assigned to each exam taker, and equivalent numbers can be posted to different private user areas of the device. Other indicators, such as placing a picture of an assigned user in a portion of the assigned private user area, color coding private user areas, etc. can be used. Additionally, tokens and/or other security artifacts can be optionally used to ensure that a correct individual (assigned a Number Y) is using a correct private user area (assigned the Number Y). A limited number of private user areas can be available for use, which can cause exam takers to wait for availability.

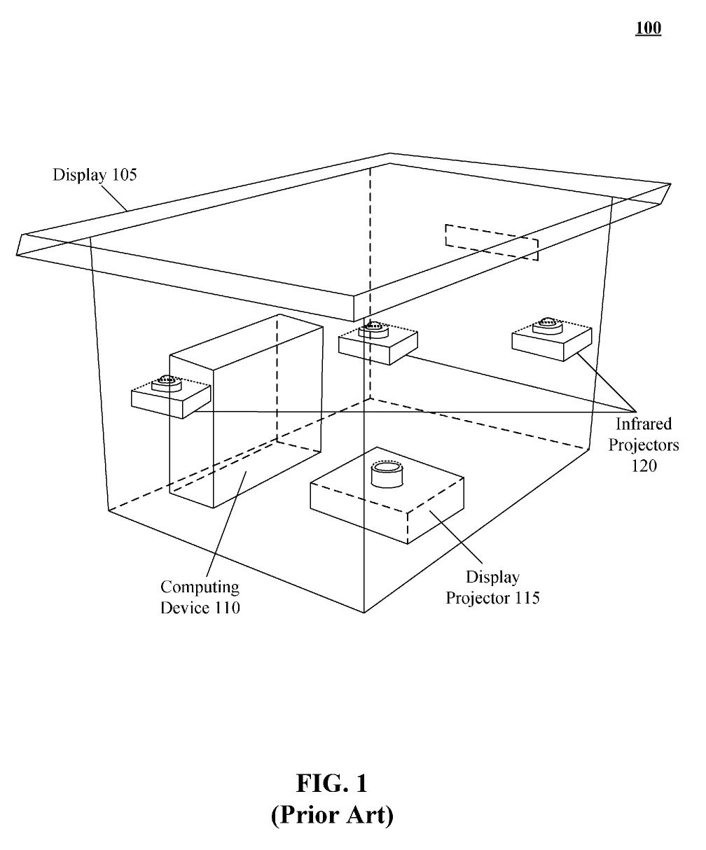

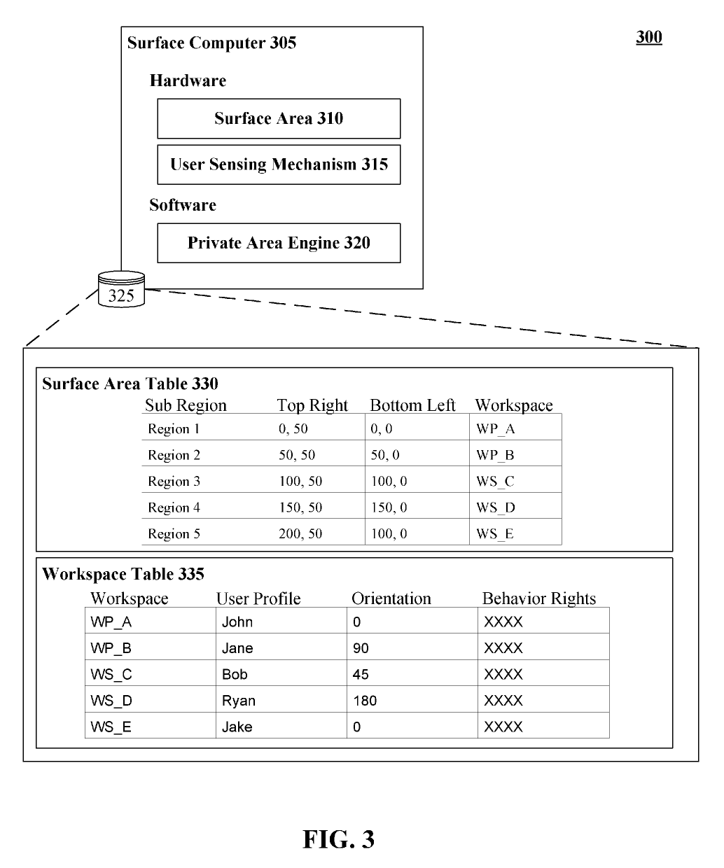

FIG. 3 is a schematic diagram of a system 300 for dividing the display area of a surface-based computing device into independent virtual workspaces in accordance with an embodiment of the inventive arrangements disclosed herein. In system 300, surface computer 305 can be a surface-based computing device capable of dividing its display area into independent virtual workspaces, each being a private user area. In system 300, surface computer 305 can include hardware, which can include surface area 310 and user sensing mechanism 315 as well as additional hardware, such as that illustrated in FIG. 1.

Surface area 310 can be the display area of the surface-based computer. User sensing mechanism 315 can be a mechanism that can detect a current user, or a user of a virtual workspace. Surface computer 305 can also include software, which can include private area engine 320. Private area engine 320 can be an engine that can handle the division of surface area 310 into independent virtual workspaces or private user areas. Surface computer 305 can include data store 325, which can store data needed to divide the display area into independent virtual workspaces. Surface computer 205 can be implemented in any way necessary to duplicate the functionality of a surface-based computing device and allow the division of the display area into independent virtual workspaces. A common current example of a surface-based computing device is the MICROSOFT SURFACE computing device.

Surface area 310 can be the display area of surface computer 305. Surface area 310 can be the flat, horizontal table-like display capable of detecting multiple touches on its surface. Surface area 310 can be implemented in many ways, including, but not limited to, a screen with a digital projector, an LCD screen, a plasma screen, or the like.

User sensing mechanism 315 can be a software engine used for determining the current user. User sensing mechanism 315 can be used to sense a different user per divided virtual workspace. A user sensing mechanism 235 can include any method of authentication for a user. Some common methods of user authentication can include, but are not limited to, a username/password combination, thumb print, typing speed, Radio Frequency Identification (RFID) detection (assuming users carry RFID tags), and the like.

Private area engine 320 can be an engine used for managing the division of the display area of surface computer 305. Private area engine 320 can provide an interface for configuring and managing the divided area. In some embodiments, private area engine 320 can allow the management of the division of surface area 310 through input provided through a multi-touch sensitive surface area 310. One management option can be the resizing and redistribution with an interface method such as dragging the borders of the divisions of surface area 310. Private area engine 320 can use user sensing mechanism 315 to determine which users are using the divided workspaces and which settings to use for those users. Private area engine 320 can use data store 325 to store information regarding the division of surface area 310, such as surface area table 330, which can store the dimensions and locations of each divided workspace and workspace table 335, which can store the user profiles and settings for each divided workspace.

Data store 325 can store surface area table 330 and workspace table 335 information. Surface area table 330 can store information regarding the division of the independent virtual workspaces and the area they take up on surface area 310. Surface area table 330 can include such fields as sub region, top right, bottom left, and workspace. The sub region field can be a field to store a unique identifier for each division. The top right field can be a coordinate on surface area 310 of the upper right corner of the division. The bottom left field can be a coordinate on surface area 310 of the bottom left corner of the division. Private area engine 320 can use the top right and bottom left corners to define the area of the division. The workspace field can be a field used to uniquely identify the workspace in the defined division.

Workspace table 335 can store information regarding the workspaces running on each divided workspace. Workspace table 335 can include such fields as workspace, user profile, orientation, behavior rights. The workspace field can be used to uniquely identify the defined workspace and can correlate to the workspace field in surface area table 330. The user profile field can be the current profile in use for the workspace and can correlate to the determined user by user sensing mechanism 315. The orientation field can be a field with the orientation of the division. The stored value can be in degrees of rotation. The behavior rights field can be used to store the permissions the user has in the divided workspace.

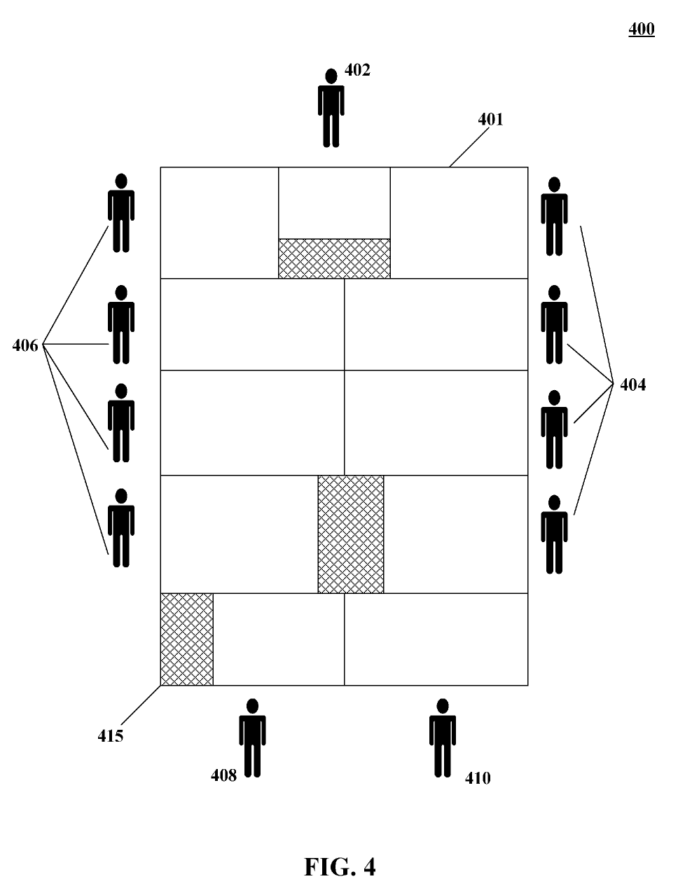

FIG. 4 illustrates a system 400 of a configuration for dividing the display area of a surface-based computing device into independent virtual workspaces in accordance with an embodiment of the inventive arrangements disclosed herein. System 400 shows the display area of a surface computer 401 with many users 402-410 around it. Surface computer 401 has been divided into many segments for each of the users 402-410. System 400 also shows unused surface area 415. These areas have been divided from the used space and reserved to perform as normal table area. Users 402-410 can have corresponding divided independent virtual workspaces. Surface computer 401 shows a sample configuration possible with the disclosed invention; however, the disclosed invention is not limited to the configuration shown.

In system 400, the top portion of surface computer 401 is split into three segments each for a user 406, user 402, and a user 404. User 402's associated division illustrates the use of an unused segment 415 to allow the use of surface area as normal table space. Table space can be used as for common uses such as papers or a drinking glass. System 400 also shows associated divisions for each user 406 and each user 404. The bottom of surface computer 401 can be split into three divisions, for an unused surface area 415, a user 408, and a user 410. This configuration shows a possible configuration in one possible embodiment. System 400 can be used in a board room situation where a surface-based computing device is implemented as a conference table. Users 402-410 can be coordinating in a meeting and the independent virtual workspaces can be divided for each coordinating member.

Surface computer 401 can be the display area of a surface-based computing device. Surface computer 401 can have a large display area intended to support many users, in situations such as a conference or a meeting, or even average social situations where users can perform computing actions socially. Surface computer 401 can be divided into independent virtual workspaces into a configuration as shown. Unused surface area 415 can be a division on surface computer 401 in which the display will not accept input. In unused surface areas 415, surface computer 401 can deactivate, or in other cases, use the area to display useful information, such as system load, memory or processor usage, or the like. Users 402 through 410 can be users engaged in using divided independent virtual workspaces on surface computer 401.

The present invention may be realized in hardware, software or a combination of hardware and software. The present invention may be realized in a centralized fashion in one computer system or in a distributed fashion where different elements are spread across several interconnected computer systems. Any kind of computer system or other apparatus adapted for a carrying out methods described herein is suited. A typical combination of hardware and software may be a general purpose computer system with a computer program that, when being loaded and executed, controls the computer system such that it carries out the methods described herein.

The present invention also may be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

What is claimed is:

1. A method for defining a private user area in a surface based computer identifying a surface of a surface based computer;
defining at least one private user area for the surface;
demarcating a region of the surface for each defined private user area; and
handling input/output for each demarcated private user area in a manner specific to the private user area, which is different from how input/output is handled for other portions of the surface.

2. The method of claim 1, wherein said at least one private user area is a plurality of different private user areas, wherein different users are associated with each of the plurality of different private user areas, and wherein each user is able to concurrently utilize their own private user area as if that private user area was a computing space dedicated to that user.

3. The method of claim 2, further comprising:
detecting an event that changes a number of users concurrently utilizing the surface;
responsive to the event, computing new sizes and positions of the private user areas to maximize a region of the surface available to the users of the surface in light of the changed number of concurrent users, each user being associated with a user specific private user area; and
dynamically changing the surface and the relative sizes and positions of the private user areas to the computed new sizes and positions.

4. The method of claim 2, wherein different ones of the private viewing areas are oriented different from other ones of the private user areas, wherein orientation of each private viewing area is based upon a position of a user relative to the surface.

5. The method of claim 1, wherein the steps of claim 1 are performed by interface management software, wherein said surface based computing device comprises:
at least one infrared projector aimed at the surface, which produce infrared emissions that are reflected back when objects touch the surface;
at least one infrared camera configured to detect reflections of the produced infrared emissions, wherein detected reflections from objects placed within the demarcated region corresponding to a private user area is considered input provided for that private user area;
at least one projector configured to produce visible emissions, which cause images and text to appear upon the surface, wherein the at least one projector is configured to generate visible emissions to produce output specific to each of the private user areas; and
a computing unit configured to receive input, to perform processing operations, and to controls output for the surface based computer, and wherein computing unit executes the interface management software, which is stored upon a machine readable medium.

6. A surface based computing device comprising:
a surface of a surface based computing device configured to detect input and to visually present output, wherein said surface is configured to be divisible into a plurality of private user areas, wherein each of the private user areas is a demarcated area of the surface to be used by a specific user, wherein different users are able to concurrently utilize different ones of the private user areas, wherein input/output associated with each of the private user areas is handled separately from input/out of other ones of the private user areas.

7. The device of claim 6, the surface based computing device is configured to detect a presence of a plurality of users, wherein when set of users concurrently utilizing the surface based computing device changes, a number of private user areas automatically changes.

8. The device of claim 6, wherein the surface is configured to dynamically resize regions of the surface allocated for each of the private user areas when a number of private user areas active upon the surface changes.

9. The device of claim 6, wherein said surface based computing device further comprises:
at least one infrared projector aimed at the surface, which produce infrared emissions that are reflected back when objects touch the surface;
at least one infrared camera configured to detect reflections of the produced infrared emissions, wherein detected reflections from objects placed within the demarcated area corresponding to a private user area is considered input provided for that private user area; and
at least one projector configured to produce visible emissions, which cause images and text to appear upon the surface, wherein the at least one projector is configured to generate visible emissions to produce output specific to each of the private user areas.

10. The device of claim 6, said device further comprising:
a computing unit which receives input, which performs processing operations, and which controls output for the surface based computer, wherein computing unit executes interface management software that is stored upon a machine readable medium, wherein said interface management software is configured to establish and maintain the private user areas for the surface based computing device.

11. The device of claim 10, said device further comprising:
virtualization software stored upon a machine readable medium, which the computing unit executes, wherein the virtualization software implements each of the private user areas as a virtual machine having it's own instance of a private user area specific instance of an operating system, which executes private user area specific instances of a set of applications.

12. The interface of claim 10, wherein a single operating system executing upon the computing unit controls the plurality of private user areas, which are each distinct virtual desktop regions handled by the single operating system.

13. The interface of claim 10, wherein a single operating system executing upon the computing unit controls the surface, and wherein a single application is executed by the single operating system, wherein said single application concurrently receives input from a plurality of different users via associated ones of the private user areas, and wherein said single application concurrently displays output to the plurality of different users via associated ones of the private user areas.

14. An interface for a surface based computer comprising:
a graphical user interface for a surface based computing device, wherein said graphical user interface comprises a plurality of private user areas, wherein each of said private user areas is a demarcated sub area of the total area of the graphical user interface, wherein the total area is concurrently utilized by a plurality of different users, each user of the plurality being associated with one of the private user areas, wherein input provided within a demarcated sub area corresponding to a private user area is attributed to a specific one of the users and is processed separately from input received from another one of the demarcated sub areas corresponding to a different private user area, and wherein output provided via each of the demarcated sub areas corresponding to a private user area is directed to a specific one of the users and has been processed separately from output directed to another one of the demarcated sub areas corresponding to a different private user area.

15. The interface of claim 14, wherein interface management software of the surface based computing device is configured to graphically display output on an approximately horizontal surface, wherein said graphical user interface is managed by the interface management software, wherein input is received for objects touching the approximately horizontal surface, wherein said surface based computing device comprises a computing unit which receives input, which performs processing operations, and which controls output for the surface based computer, wherein computing unit executes the interface management software, which is stored upon a machine readable medium.

16. The interface of claim 15, wherein each of the private user areas is dynamically defined based upon at least one of a detection of a user presence and a receipt of a user provided input.

17. The interface of claim 15, wherein each of the private user areas is a software implemented virtual machine having it's own instance of a private user area specific instance of an operating system, which executes private user area specific instances of a set of applications, wherein software executing in the computing unit defines each of software implemented virtual machines.

18. The interface of claim 14, wherein for each private user area, a user is identified and authenticated by software executing in the computing unit, and wherein software executing in the computing unit grants user specific permissions to access computing resources available to the surface based computing device for each of the private user areas.

19. The interface of claim 14, wherein a single operating system controls the plurality of private user areas, which are each distinct virtual desktop regions handled by the single operating system.

20. The interface of claim 14, wherein a single operating system controls the graphical user interface, and wherein a single application is executed by the single operating system, wherein said single application concurrently receives input from the plurality of different users via associated ones of the private user areas, and wherein said single application concurrently displays output to the plurality of different users via associated ones of the private user areas.
